(19) United States
(12) Patent Application Publication
(10) Pub. No.: US 2026/0046238 A1
(43) Pub. Date: Feb. 12, 2026

(54) TRAJECTORY MINING FOR DATA MESSAGE ROUTING

(71) Applicant: HSBC Group Management Services Limited, London (GB)

(72) Inventors: Georgios Korpas, Singapore (SG); Dimitris Kaklis, Marousi (GR)

(21) Appl. No.: 18/895,740

(22) Filed: Sep. 25, 2024

(30) Foreign Application Priority Data
Aug. 8, 2024 (GR) 000003119

(51) Int. Cl. H04L 45/02; H04L 12/14

(52) U.S. Cl. CPC H04L 45/08; H04L 12/1482

(57) ABSTRACT

A methodological technical approach is proposed herein that utilizes historical data to employ a heuristic optimization algorithm for data message routing. While not specifically limited to the banking sector and financial institutions, as a practical example, the approach can utilize historical data relating to patterns of transactions for analyzing customer behavior and detecting fraudulent activities. For example, trajectory mining can be used to analyze the transaction patterns of credit card users, or behavioural patterns of mobile banking users, such as checking account balance, transferring funds and paying bills.

### FIELD

Embodiments of the present disclosure relate to the field of data message routing, and more specifically, embodiments relate to devices, systems and methods for data message routing using reinforcement learning/quantum analog trajectory mining approaches for determining an optimized data message routing pathway.

### INTRODUCTION

Trajectory mining (TM) is a data mining technique used to extract knowledge from trajectory data, which refers to the sequence of locations visited by an object over time.

In the transportation domain, trajectory mining has been used to analyze traffic patterns and predict congestion sites. In healthcare, it has been applied to study patient movements and predict disease outbreaks. In security, it has been used to analyze the movement of people and vehicles to detect suspicious activities.

Trajectory mining is computationally complex and presents a difficult computational problem as the problem complexity scales up significantly as the number of potential paths scales. Optimized pathfinding is a non-trivial and unsolved computer science problem, and significant computing resources are devoted to identifying optimal pathways from a large potential search space. Optimal pathways (relatively optimal given the computing constraints—not necessarily absolutely optimal) can be practically translated into routing decisions, such as those provided in a routing table.

### SUMMARY

A methodological technical approach is proposed herein that utilizes historical data to employ a heuristic optimization algorithm for data message routing. While not specifically limited to the banking sector and financial institutions, as a practical example, the approach can utilize historical data relating to patterns of transactions for analyzing customer behavior and detecting fraudulent activities. For example, trajectory mining can be used to analyze the transaction patterns of credit card users, or behavioural patterns of mobile banking users, such as checking account balance, transferring funds and paying bills.

Data can be acquired from financial institutions and may include features describing payments conducted in the past, such as, originator & beneficiary bank, amount, payment type, etc.

Homogeneous partitions of routes corresponding to payments of the same or very similar type are determined, and this extraction of route payment patterns is initiated by constructing clusters of data that describe similar segments of routes, in terms of origin, destination, payment type, date processed, instructions and payment status, and clusters are identified by the convex hull of the data points.

An advantage of this approach is the ability to adapt to different regions and exploit either stochastic or deterministic principles depending on the internal network's volatility. By using convexity-based modeling, the approach can take advantage of both randomised decision rules and Bayes rules, which are particularly useful in volatile environments where traditional modeling techniques may not be sufficient. Additionally, the system can be configured to leverage more deterministic schemes, such as Delaunay triangulation and Voronoi diagrams, to better understand and model the underlying structure of the relevant networks.

The approach proposed herein to classify data in categories, includes coupling of various algorithms to initially filter the data from any inherent noise (Douglas-Peucker algorithm) and then group them utilizing density-based clustering approaches (DBSCAN). This builds an informed network topology G=(V,E), that defines a versatile range of data message (e.g., payment processing) pathways via network's nodes V and edges E.

A dense network is established that defines the data message navigational boundaries (e.g., payment message) in terms of overall cost and time consumed during a transaction. This network of past routes can then be leveraged for automating and expediting the decision-making process, proposing alternative optimal routes in terms of cost, security and time consumed for financial institutions.

In operation, this network can be utilized to establish a custom grid data structure that is configured for identifying and querying the appropriate set of clusters (past trajectories) based on a specific originator node and target node (e.g., nodes representing an originator bank and a beneficiary bank).

Once the grid data structure is generated, the grid data structure can be transformed to attach a weighting (prop. dist.) that quantifies, depending the initial-steady state of the system, the likelihood of each waypoint to be visited.

Embodiments herein can instantiate a pathfinding algorithm (e.g., a reinforcement learning (RL)-quantum analog algorithm but not necessarily RL-quantum), and the weightings can be updated with real-time data. The pathfinding algorithm operates by deriving an “optimal” policy by interacting with a dynamic environment. The algorithm can be practically utilized for identifying a path across a set of waypoints when an originating node and a target node are identified, such as between banks and other financial intermediaries for a payment transaction, determining the most efficient path for the payment to follow, and ensuring that the payment is properly credited to the recipient's account. Payment routing is important in the banking sector because it helps ensure that electronic payments are processed accurately, securely, and efficiently. It also helps to minimize transaction costs, reduce the risk of fraud or errors, and ensure compliance with regulations and industry standards.

In some embodiments, if the pathfinding algorithm has subroutines, the subroutines can be substituted by quantum subroutines. For example, matrix inversion can be substituted into the pathfinding algorithm to simplify the approach.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is a point cloud diagram showing an example payment trajectory cluster, according to some embodiments.

FIG. 1B is a point cloud diagram showing an example payment trajectory cluster, according to some embodiments.

FIG. 1C is an example diagram showing a path that is generated using clusters, and their associated centroids.

FIG. 2 is a point cloud diagram showing an example set of extracted clusters corresponding to a specific path, according to some embodiments.

FIG. 3 is an example flow chart representing a process performed by the data message routing system, according to some embodiments.

FIG. 4 is an example computing system diagram showing an example practical computing system for implementing the system for optimizing data message routing, according to some embodiments.

FIG. 5 is a block schematic diagram of an example system, according to some embodiments.

### DETAILED DESCRIPTION

An improved computing approach is proposed herein, utilizing generated data structures representing routing nodes and related weighted interconnections for modelling data message routing waypoints. As there can be a large number of different waypoints and thus routes between an originating node and a target node, determining an optimized path is non-trivial, and a reinforcement learning based approach is proposed in embodiments herein that utilizes a pathfinding algorithm to generate optimised pathways in real or near-real time in a dynamically updated system to minimize the computational cost of exploring the large amount of waypoints. In some embodiments, the pathfinding algorithm is a quantum analog based reinforcement learning algorithm.

The pathfinding approach includes conducting a data structure transformation using clustering approaches to represent groups of individual points as convex hulls, effectively replacing the individual points with the convex hulls and characteristics (e.g., centroids) for the purposes of simplified wayfinding. This data structure transformation can be conducted recursively such that a next level of convex hulls based on previously generated convex hulls can be continually generated to a depth of recursion. The convex hulls of a final layer can be used to generate a waypoint path between centroids, for example, of the hulls, and if a potential path can be generated, the recursively generated convex hulls can be decomposed one by one for individual pathfinding steps as between the individual points within each layer of convex hulls.

This pathfinding approach is technically useful when the pathfinding is computationally extremely complex, and there is an impractically large number of points for optimizing as there can be an impractically large number of potential pathways. As the computational analysis after each recursion step is limited only to the points or convex hulls from the last step, the computational steps are significantly reduced, improving the ability of the computer to practically generate an optimized path (not necessarily the absolute optimal path) given a finite amount of computing resources and processing time.

This is particularly useful in situations where the available computing resources are constrained (e.g., a large volume of paths need to be identified), or where processing time is constrained (e.g., a need to generate paths in real or near-real time, due to node characteristics becoming stale and thus not reliable as time passes, or where there is a practical time constraint). An example practical time constraint may be where a particular pathway is being generated to route a payment transaction that needs to occur promptly, for example. Another scenario where the approach is useful is where each node/point is represented at a high level of dimensionality (e.g., a large number of characteristics are defined for each payment processor), and the approach can be used to significantly improve computational speeds. For example, using the approaches described herein may allow for 500 dimensions to be used instead of 5 dimensions per node, allowing a greater level of informational resolution for pathfinding.

The high level of dimensionality can be used to infuse the data set with additional elements of information in addition to advertised characteristics (e.g., price of using the node and advertised speed/reliability), such as past experiences relating to the particular node (actual price speed/reliability). As the number of dimensions scales upwards, clustering using machine learning approaches at each level of recursion obtains improved analytical value, but the computational requirements also scale, and as described herein, various embodiments are adapted to provide a practical proposed approach for allowing for this improved analytical resolution while also reducing the search scope at each recursive step in an effort to constrain the overall computational requirements within practical limitations.

The computing approach can be practically implemented as a physical computing system configured for receiving data sets (e.g., over a message bus) representative of historical interaction data (e.g., payments data), the historical information including data separated in respect of a number of different fields representing transaction characteristics.

The computing system can be configured to maintain, on non-transitory computer readable storage media, the graph data structure representations and/or cluster representations representative of homogenous partitions of routes obtained through a clustering analysis. This graph data structure can be dynamically updated as new data is provided into the system. Responsive to a request for a pathway between two nodes represented in the graph data structure, the physical computing system can be configured to process the desired pathway request message to output a routing data structure representative of a path traversing a set of waypoints between the two nodes. The graph data structure can be stored at a number of different levels of hulls, sub-hulls, sub-sub-hulls, etc., allowing for pre-determination and machine learning classification steps to be conducted prior to run-time, for example, as a nightly batch process. In some embodiments, a recursion limit is pre-defined to establish how many levels of classification need to be conducted for prior calculation. Where the recursion limit needs to be breached for an analysis, the additional determinations can be done instead in real-time until a practical path is generated at a particular recursive depth of n-level sub-hulls, to be recursively unpacked all the way back to establish the practical path as between individual nodes.

To establish the set of graph data structure representations, a methodological technical approach is proposed herein that utilizes historical data to employ a heuristic optimization algorithm for data message routing. While not specifically limited to the banking sector and financial institutions, as a practical example, the approach can utilize historical data relating to patterns of transactions for analyzing customer behavior and detecting fraudulent activities. For example, trajectory mining can be used to analyze the transaction patterns of credit card users, or behavioural patterns of mobile banking users, such as checking account balance, transferring funds and paying bills.

As another example, embodiments herein can utilize real-world data originating from the maritime industry by acquiring a vast amount of data corresponding to historical routes of cargo-vessels (e.g., 104 routes or round time voyages of cargo and container ships) in the Mediterranean sea. Raw automatic identification system (AIS) data are acquired by transmitters installed on board cargo-vessels, synchronizing at fixed intervals to the closest AIS station, where the AIS data can be aggregated and stored in streams via a TCP/IP protocol. The AIS data can consist of the vessel coordinates at a specific time, the vessel speed that corresponds to the overground speed (GPS speed) and the vessel overground heading.

Embodiments herein utilize a clustering procedure consisting of extracting the waypoints, identifying the routes between an originating node and a target node, interpolating the AIS positions for each trajectory, and utilizing DBSCAN algorithms to cluster and group trajectories.

For example, for the previous maritime industry application, the first step is extracting waypoints. Waypoints can be defined as regions at sea where the vessels come to a complete stop, thus indicating ports or anchorage areas. By identifying such areas, original and destination points of a vessel's trip can be determined. The system then identifies the routes by segmenting the trajectories of the vessels based on the extracted waypoints to incorporate the origin and destination ports into the dataset, creating sub-trajectories that begin and end at a waypoint. The system then interpolates the AIS positions of each trajectory to fill in any gaps that may arise in real vessel trajectories, which can affect the quality of the extracted traffic patterns and the quality of the trajectory clustering. Trajectories involving multiple vessels following the same route (i.e., from waypoint to waypoint) are clustered using a modified iteration of a DBSCAN algorithm based on various factors, including at least the geographical location, speed, and heading of the AIS positions.

Table 1 shows example factors that the trajectory clustering can be based on:

| | CELL_{—} | MEAN_{—} | STD_{—} | MIN_{—} | MAX_{—} | MEAN_{—} | STD_{—} | MIN_{—} | MAX_{—} |
|---|---|---|---|---|---|---|---|---|---|
| | ID | HEADING | HEADING | HEADING | HEADING | SPEED | SPEED | SPEED | SPEED |
| 1 | 13281 | 178.000000 | 0.000000 | 178.0 | 178.0 | 9.466667 | 8.164966e−02 | 9.3 | 9.6 |
| 2 | 13281 | 177.000000 | 0.000000 | 177.0 | 177.0 | 9.625000 | 6.614378e−02 | 9.5 | 9.7 |
| 3 | 13050 | 179.400000 | 0.469898 | 179.0 | 180.0 | 9.800000 | 1.776857e−15 | 9.8 | 9.8 |
| 4 | 12173 | 241.333333 | 0.745356 | 240.0 | 242.0 | 8.766667 | 7.453560e−02 | 8.7 | 8.9 |
| 5 | 15083 | 49.000000 | 0.000000 | 49.0 | 49.0 | 12.580000 | 8.717798e−02 | 12.4 | 12.7 |
| 6 | 15084 | 48.000000 | 0.000000 | 48.0 | 48.0 | 12.975000 | 1.089725e−01 | 12.8 | 13.1 |
| 7 | 15316 | 46.672727 | 1.251247 | 44.0 | 50.0 | 12.623636 | 1.255383e+00 | 11.0 | 17.9 |
| 8 | 15316 | 50.789474 | 1.104009 | 49.0 | 53.0 | 12.336842 | 7.117144e−01 | 11.3 | 13.1 |
| 9 | 15316 | 48.666667 | 0.471405 | 48.0 | 49.0 | 20.766667 | 4.714945e−02 | 20.7 | 20.8 |
| 10 | 9343 | 102.625000 | 1.111024 | 101.0 | 104.0 | 9.600000 | 0.000000e+00 | 9.6 | 9.6 |
| 11 | 15315 | 46.000000 | 0.000000 | 46.0 | 48.0 | 12.828571 | 2.015248e−01 | 12.5 | 13.1 |
| 12 | 12877 | 226.500000 | 5.852350 | 216.0 | 237.0 | 13.900000 | 1.044031e+00 | 12.0 | 15.0 |
| 13 | 12877 | 176.333333 | 5.906682 | 170.0 | 188.0 | 14.150000 | 1.022660e+00 | 12.0 | 15.0 |
| 14 | 9067 | 80.062500 | 1.712774 | 78.0 | 83.0 | 8.006250 | 1.748884e−01 | 7.7 | 8.3 |
| 15 | 9566 | 242.125000 | 0.330719 | 242.0 | 243.0 | 17.175000 | 6.614378e−02 | 17.1 | 17.3 |

Data can be acquired from financial institutions and may include features describing payments conducted in the past, such as, originator & beneficiary bank, amount, payment type, etc. This data can be structured in the form of a payment data payload having a number of values corresponding to different fields, each representing a different characteristic. Homogeneous partitions of routes corresponding to payments of the same or very similar type are determined, and this extraction of route payment patterns is initiated by constructing clusters of data that describe similar segments of routes, in terms of origin, destination, payment type, date processed, instructions and payment status, and clusters are identified by the convex hull of the data points.

As noted above, using the data transformation approach and corresponding recursive convex hull determination and pathfinding allows for a greater number of dimensionality to be coupled to each of the payment processors, allowing extended data fields or characteristics to be captured. As described in a further embodiment, the extended data fields or characteristics, instead of only real-world characteristics, also include machine generated perturbations to further enhance a search scope or to allow for scenario testing. The perturbations can, for example, represent modelled expected responses to real world phenomena, such as the impact/resilience to increased volume/load on a particular node, representations of jitter and uncertainty, among others.

Unsupervised learning approaches in a reinforcement learning approach can be used for the recursive clustering, which allows for emergent patterns to be captured without explicit programming. The combination of these approaches allows for an improved path finding approach with a greater level of efficiency during run-time inference performance, at the cost of additional computing cycles being used for the recursive clustering and pathfinding, potentially requiring additional data storage and data transformation steps. Accordingly, these computational trade-offs are more valuable when computing/processing resources are significantly constrained, where there is a desired high level of dimensionality, and/or where there are a large number of points in a constellation of potential nodes.

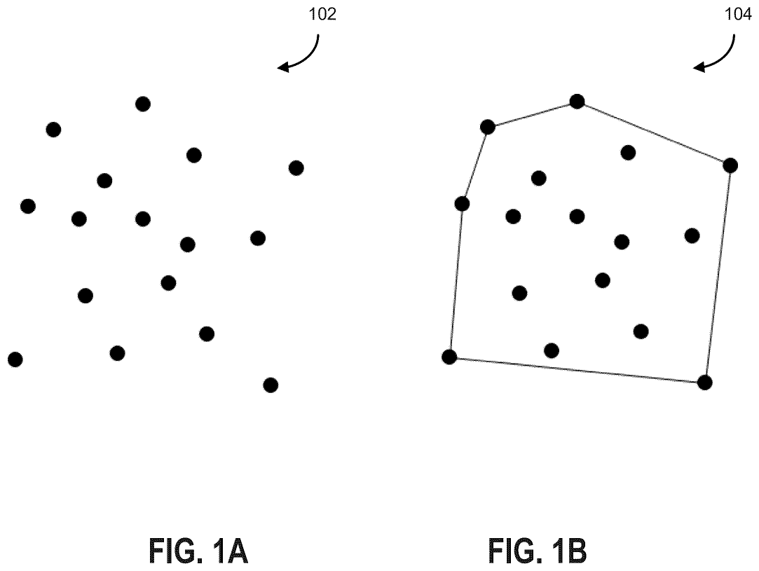

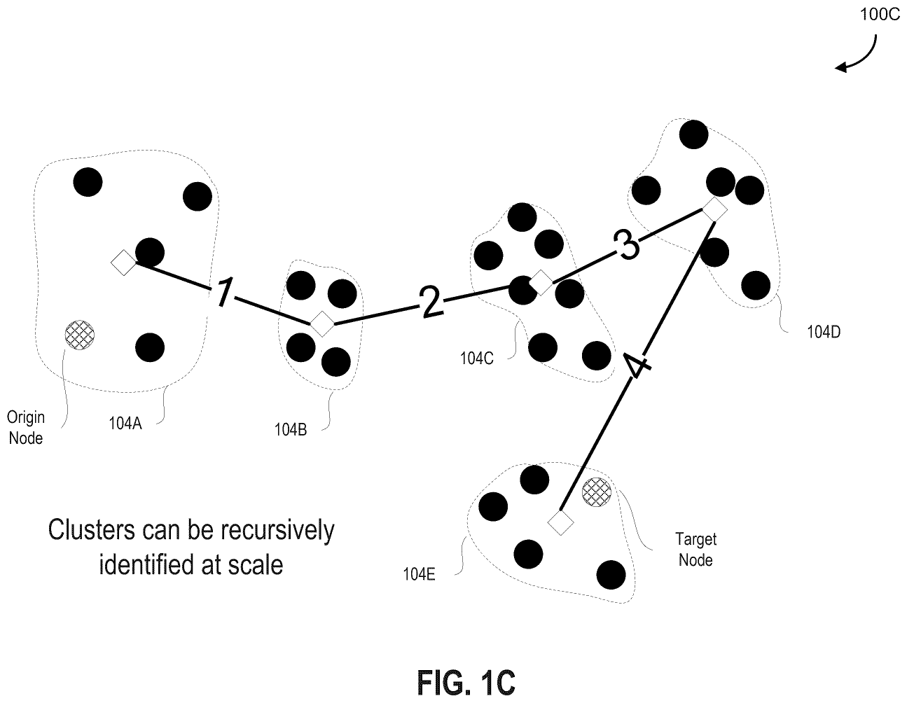

FIG. 1A and FIG. 1B are point cloud diagrams showing an example payment trajectory cluster, according to some embodiments. In FIG. 1A, a payment trajectory cluster 102 is shown, and at FIG. 1B, a convex hull 104 is identified in respect of the cluster of FIG. 1A. Each point inside the clusters shown in FIG. 1A and FIG. 1B represents a waypoint that belongs to a certain payment trajectory displayed in a two-dimensional or three-dimensional space. Each convex hull 104 represents the clustering outcome of multiple payment trajectories that meet certain criteria (e.g., type of payment, cost, processing time, etc.). For example, in the banking industry, the corresponding positions of the waypoints can be determined by coordinates representing the identifier of the financial institution that the payment was processed by and the particular timestamp of the payment. For example, in the maritime industry, the corresponding positions of the waypoints can be determined by coordinates representing the latitude, longitude, and timestamp of the vessels' positions. As described below, the convex hull 104 is utilized as part of the clustering process to identify and establish a number of separate clusters.

Each convex hull 104 can be defined having a centroid, which may not necessarily be an existing point in the cluster, but rather, can be a representation point used for search optimization purposes, as an intermediate data output that is used for effectively improving the search efficiency by using a transformed data structure. As described herein, instead of conducting an initial waypoint generation using specific points (which is a computationally very difficult and complex problem), a new intermediate computing step is conducted whereby the convex hull 104s are each generated, and connected, to create a simplified graph for traversal.

FIG. 1C is an example diagram 100C showing a path that is generated instead using the clusters, and their associated centroids. In this example there are multiple convex hulls 104A, . . . 104E, and a pathway is generated from convex hull 104A to convex hull 104B, and so forth.

In some embodiments, clusters can be generated in a recursive manner by processing each waypoint belonging to a trajectory and then recursively adding new waypoints similar to the origin point with a depth-first search (DFS) algorithm. For example, the threshold that outlines the depth of the DFS algorithm in the banking industry could be the number of financial institutions comprising a certain cluster or the total amount that was processed in these institutions.

After the rough pathway is generated from convex hull to convex hull, the rough pathway can then be refined to ultimately identify specific nodes within each hull for controlling the routing. A benefit of this approach is that the traversal using the convex hulls significantly reduces the computing burden for the rough pathfinding, at the increased cost of initial computing overhead, which is a computational trade-off for overall improved heuristic performance given a fixed computing resource constraint.

A convex hull 104, in this example, can be defined as a data structure or data object comprising a set of points, represented by coordinates, corresponding to historical payment routes (financial institution). The centroid of the convex hell 104 represents the inherent attributes of the points compiling the convex hull 104. For example, the centroid can be the point that is closest to the average of the attributes that comprise the cluster of points (e.g., average processing time, average amount of money, etc.). For example, the convex hull 104 is defined as a computational region minimally encompassing a set of related points, and a process to determine the area or bounds of a convex hull 104 can include first identifying the set of members of the hull through a classification approach, and then drawing the bounded region, and finally establishing characteristics of each convex hull 104, based, for example, on a centroid of the convex hull 104.

An advantage of this approach is the ability to adapt to different regions and exploit either stochastic or deterministic principles depending on the internal network's volatility. By using convexity-based modeling, the approach can take advantage of both randomised decision rules and Bayes rules, which are particularly useful in volatile environments where traditional modeling techniques may not be sufficient. Additionally, the system can be configured to leverage more deterministic schemes, such as Delaunay triangulation and Voronoi diagrams, to better understand and model the underlying structure of the relevant networks.

The approach proposed herein to classify data in categories, includes coupling of various algorithms to initially filter the data from any inherent noise (Douglas-Peucker algorithm) and then group them utilizing density-based clustering approaches (DBSCAN).

This builds an informed network topology G=(V,E) for the payment routing network, that defines a versatile range of data message (e.g., payment processing) pathways via network's nodes V and edges E. The clustering is based on an identification of appropriate datasets (historical data on payments processed) and features describing the data comprised, such as: originator bank, beneficiary bank, correspondent bank, payment type, payment amount, currency payment date, payment reference, payment transaction, payment instructions, payment status.

The payment routing network topology is a dense graph with each node V representing a different bank and each edge E connecting the financial institutions representing a payment pathway. The goal of traversing the graph is to find the most efficient route for transferring funds from one bank to another. Each pathway between the banks has specific characteristics or weights that determine how suitable the pathway is for a transaction. The weights include the cost of transferring money (e.g., a fare), the time it takes for the transfer to complete (e.g., travel time), and the reliability of the pathway (e.g., how often trains arrive on time).

The topology includes, for example, possible financial intermediary nodes existing inside the clusters, and the system can be used to propose alternative routes to process specific payments, and also for evaluation of a feasibility and efficiency of proposed alternative payment route. The topology is a dense network that defines the data message navigational boundaries (e.g., payment message) in terms of overall cost and time consumed during a transaction. This network of past routes can then be leveraged for automating and expediting the decision-making process, proposing alternative optimal routes in terms of cost, security and time consumed for financial institutions.

For example, a payment routing network could have four banks A, B, C, and D. The pathway from Bank A to Bank B could have a cost of $5, processing time of 2 hours, and a 95% reliability rate. The pathway from Bank B to Bank C could have a cost of $3, processing time of 1 hour, and a 90% reliability rate. The pathway from Bank A to Bank D could have a cost of $7, processing time of 4 hours, and a 99% reliability rate. The pathway from Bank D to Bank C could have a cost of $2, processing time of 3 hours, and a reliability rate of 85%. These characteristics of the pathways are factors the payment routing algorithm will consider in determining the best route for a transaction, balancing cost, time, and reliability. This is a simplified example. A core benefit of the proposed approach herein include situations there are many more variables being considered, scaling up analytical utility but also having a corresponding effect on significantly scaling up computational complexity.

A payment pathway that has a low cost, quick processing time, and high reliability is considered to be a strong connection. For example, the connection from Bank B to Bank C could be considered strong if it consistently offers a fast and affordable transfer with a high success rate. This pathway may be frequently chosen for its overall efficiency and reliability.

A payment pathway that has a high cost, long processing time, or low reliability is considered to be a weak connection. For example, the connection from Bank A to Bank D, despite its high reliability, may be considered to be weak due to its higher cost and longer processing time compared to other routes. The algorithm may avoid choosing this pathway unless no better options are available or other pathways are overloaded.

In operation, this network can be utilized to establish a custom grid data structure that is configured for identifying and querying the appropriate set of clusters (past trajectories) based on a specific originator node and target node (e.g., nodes representing an originator bank and a beneficiary bank).

The methodological approach is employed to extract clusters of historical payment trajectories, for a predefined payment desired to be processed (originator-beneficiary banks).

The process is initiated by acquiring nodes (financial intermediate channels) where a certain payment can be processed. Based on this broad grid, routing optimization algorithms can be utilized, such as the A*-algorithm (A*) to extract an approximation of an optimal processing route between our origin and destination points.

A* is a heuristic search algorithm, that is used for pathfinding and routing optimization problems. It is a best-first search algorithm, that aims to find the shortest path between two points in a graph by combining both the actual cost of the path and an estimate of the remaining cost to the goal. This estimate is typically based on heuristics such as the Euclidean distance or Manhattan distance between the current node and the goal node. A* incorporates a cost function ƒ(n) that combines both the actual cost g(n) of the path from the start node to the current node n and an estimate of the remaining cost to the goal node, denoted by h(n), i.e.,

$$f ( n ) = g ( n ) + h ( n ) . \qquad ( 1 )$$

The algorithm uses this cost function to prioritize the exploration of nodes with values lower than ƒ(n), as these are likely to lead to a shorter path to the goal node.

Furthermore, A* uses a priority queue to keep track of the nodes that have been evaluated but not yet expanded. The priority queue orders the nodes based on their ƒ(n) values, with the node with the lowest ƒ(n) value at the front of the queue. The priority queue is a data structure that contains and orders nodes based on their estimated total cost, combining the actual cost from the start node and the heuristic estimate to the goal node. The priority queue can be implemented using a min-heap for efficiency with each node in the priority queue implemented as an object or class instance containing attributes such as the current path cost (g), the heuristic cost (h), and the total estimated cost (ƒ=g+h). This allows the algorithm to efficiently expand the most promising nodes first, ensuring an optimal path is found in an efficient manner.

Beginning with the initial node (representing the starting point), the algorithm inserts the initial node into the priority queue with its total cost calculated as ƒ=g+h. For example, if the start node's g (cost from start) is 0 and h (heuristic estimate to goal) is 5, then ƒ would be 0+5=5. The priority queue, implemented as a min-heap, would prioritize this node.

The algorithm proceeds by iteratively selecting the node with the lowest ƒ(n) value from the priority queue, expanding it and its neighbors, calculating the nodes' respective ƒ(n) values, and adding its neighboring nodes to the priority queue.

The algorithm continues until the goal node is reached, at which point the path is reconstructed, or the priority queue becomes empty, indicating that no path exists. For example, if nodes are expanded and the goal node is found with a final cost ƒ, the algorithm stops, having found the optimal path. The candidate route employed, might have several inherent disadvantages and issues. Some of these could potentially correspond to time-consuming, cost inefficient payment processing options.

These characteristics make the route sub-optimal in terms of practical utilization for the use cases being contemplated. To make the route feasible, it would involve building a dynamic graph for each node and discovering possible alternative pathways, by taking into account various constraints. However, this process could be time-consuming and computationally expensive, and may require a substantial investment of resources.

A primary issue with A* is its memory usage as it requires storing all explored nodes into memory to avoid revising them and to reconstruct the path once the goal is reached. As the problem size grows, the number of nodes that would need to be stored increases exponentially, resulting in high memory consumption that can exceed the capacity of even the most advanced hardware.

Another significant limitation of A* in large-scale applications is its computational complexity. The algorithm's time complexity is heavily dependent on the accuracy of the heuristic used. In scenarios where the heuristic is not completely accurate or admissible (e.g., underestimating the actual cost), A* can end up exploring a large number of nodes, similar to a breadth-first search, resulting in a large number of operations and consequently, long computation times. For extensive networks, such as those found in large-scale logistics, urban traffic systems, or global internet routing, the large volume of nodes and connections can make the algorithm impractically slow.

The A* algorithm can also be infeasible in dynamic or real-time systems. Large-scale implementations often require systems to adapt to changing conditions, such as traffic updates, network failures, or new obstacles. A* typically operates on a static graph where any changes would require re-running the algorithm from the beginning, which is computationally expensive. In real-time applications, the delay of re-running the algorithm would be impractical. For example, in real-time navigation systems or dynamic financial trading networks where decisions need to be made almost instantaneously or in milliseconds, the overhead of recomputing with A* can be prohibitive in the process, making it unsuitable for such environments without significant modifications or hybrid approaches.

To overcome this technical deficiency, it is proposed herein to exploit as basis the initial route employed, for derivation (query) of the ideal set of clusters containing segments of payment trajectories processed by nodes (e.g., banks) in the past. The clusters contain dense and concentrated information about a large number of waypoints corresponding to historical payment transactions so each cluster can be assigned a representative point outlining the bounds of distribution inside the cluster, significantly reducing the processing time of the path-finding algorithm.

Each cluster is described by the convex hull (polygon H) of the nodes (candidate intermediate channels in the banking network) lying on the boundaries, and a set of features outlining the trajectories comprising this specific cluster (processing rates, time consumed, success rates, etc).

In order to extract the set of clusters corresponding to this route, the proposed approach utilizes the centroid of each polygon and determines the distance from each node extracted by the shortest path route employed by:

$${{min}_{i = 1}}^{M} Dist ( c , {V}_{i} ) \qquad ( 2 )$$

where M is the number of nodes, c is the centroid of the cluster and Vᵢ is the candidate intermediate node (e.g., financial node/waypoint).

One can define distance as an appropriately established metric outlining similarity in a set of intermediate financial channels comprising a broader network G in terms of payment type, rates, processing time consumed, etc.

In some embodiments, the algorithm for cluster extraction based on a path can be implemented according to the following pseudocode:

Shortest path by A*S_{P}←A* based on grid G Convex Hull of clusters C_{H}←from initial processing Centroids Cᵢ←from C_{H}: initialize empty clusters list Cₗ

```
for each Vᵢ ∈ S_{P} do
  for each cᵢ ∈ C_{H} do
  for each cᵢ ∈ C_{H} do
    if Dist(cᵢ, Vᵢ) < dist then
    add cᵢ to Cₗ
Return Cₗ
```

The intermediate output of the algorithm described above is a subset of clusters, bounded in terms of similarity from the path initially employed by A*. These clusters contain historical trajectories of payments of the same or similar type of the payment route we want to optimize. Each subset of clusters is described by a convex hull and a set of features such as processing rates, time consumed, and success rates. These clusters enhance the efficiency and accuracy of payment routing optimization to help make more informed routing decisions to find the most efficient pathways.

The intermediate output is generated by first determining the shortest path using the A* algorithm on a grid G, which represents the broader network of financial channels. Each node on this path is then evaluated against the centroids of precomputed convex hulls, which represent clusters of similar payment routes. The distance between each node on the path and the centroids of the clusters is calculated using an appropriate metric that captures similarities relating to payment type, rates, processing time, and other relevant features. Nodes that fall within a certain threshold distance from a cluster centroid are considered to be part of that cluster and added to the clusters list (CL).

The process ensures that the extracted clusters are highly relevant to the payment route being optimized, containing historical data that closely matches the current transaction's characteristics. The final output is a refined set of clusters that provide a narrower and more manageable dataset for further optimization. These clusters can be used to predict the most efficient route for the current payment by leveraging historical data to identify patterns and trends.

The clusters can be recursively generated such that a highly complex constellation of high dimensionality points (e.g., millions of points each having 100-200 variables) that are possible for traverse from origin to goal can be recursively converted into clustered hulls such that subsequent recursion layers are clustered sub-hulls generated from a previous round of clustered hulls, and so on, until there can be a practical path between the sub-hulls corresponding to the origin node to the sub-hulls corresponding to the goal node. It is important to note the origin nodes and the goal node, and the points along the way, are all clustered in the form of individual sub-hulls corresponding to a layer level of the recursion. A practical path can be defined as a path that satisfies the bounded constraints that are provided into the system, and these can be incorporated into the form of an objective function for path evaluation. The bounded constraints need not be specific thresholds, but in some embodiments, are instead a set of weighted components that together form the objective function for threshold evaluation.

The identified practical path can be based on attempts to optimize a specific objective function that is tailored for a particular type of transaction being proposed, representing a balance between desired transaction outcomes, for example (e.g., high reliability at a reasonable price and execution time), among others.

At that point, as noted herein, the approach includes unpacking the sub-hulls along the practical path for that layer of recursion, conducting the pathfinding analysis again only on the points in the sub-hulls along the practical path.

A depth of recursion can be pre-determined in some embodiments, or in another variation, the depth of recursion can be set to be dynamic. With a dynamic depth of recursion, the recursive approach for pathfinding continues at each level if there are not sufficient computing resources to practically generate a path between the origin and goal nodes.

Accordingly, a next layer of recursion is automatically instantiated in an automated attempt to simplify the computation. This can continue until a path is possible or where a max depth limit has been reached, and the path is returned as inconclusive. As noted in practical variations herein, a number of levels of depth can be pre-calculated and stored in memory to reduce an overall number of classification computing calculations to be done in real-time, and if those levels of depth are surpassed in the dynamic depth of recursion, only then are the classification computing calculations are done in real-time, allowing for a balance between pre-compute and real-time computing costs.

Once a next practical path is generated, the next layer is unpacked, and so on until the approach returns to the original points in the constellation, and a pathway is ultimately established between the origin node (not a hull or sub-hull thereof) and the goal node (not a hull or sub-hull thereof). Because the recursive approach limited the total available search scope at each level of recursion (e.g., limited to those on the previously generated path), the total computing time is significantly reduced and the ability of a practical computer to function has been practically improved in view of practical computing constraints.

The final pathway is then converted from a pathway of nodal interconnections to a set of data routing computing instructions, which can be a series of data messages and execution instructions that are provided to route a data message from the origin node to the goal node. These data messages can include specific operational and execution characteristics for each intermediate processing node. The series of data messages or execution instructions can represented as a routing table that can be used during the message routing, creating a practical mechanism for improving message routing outcomes at scale.

As the approach can be used to significantly reduce computational time requirements, a variant embodiment includes using the additional available time to also conduct pathfinding across a number of perturbed variations of the objective function, based on bounded acceptable ranges, and a number of different pathways are generated for each of the perturbed variations. These pathways can then be combined together where possible or used for further decomposition to vary the pathway used as the final pathway for routing. This approach helps improve the robustness of the final pathway in respect to intermittent changes or ephemeral changes in tracked nodal processing behavior/characteristics.

An example situation where this approach is particularly useful is transferring of funds between two disparate countries where there are no direct interconnections. Rather, the corresponding payment instructions will require funds to be transferred across a number of intermediaries. In a modern payment transaction network, these funds transfers can be conducted electronically. However, there may be a large constellation of service providers and intermediaries along the path, and optimizing this mix may allow for improved computational or robustness outcomes for the message, and the approaches proposed herein allow for a heuristic-based improved approach for generating the corresponding routing table.

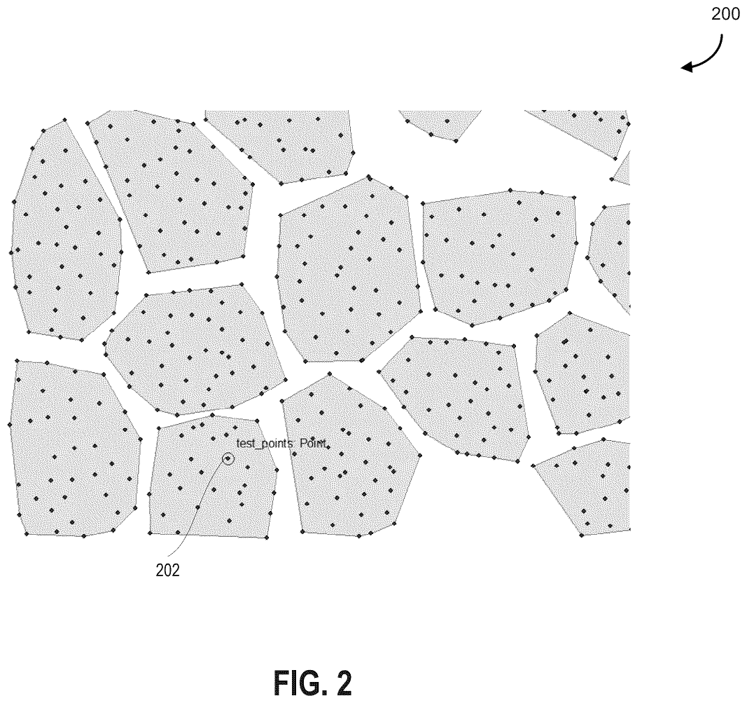

FIG. 2 is a point cloud diagram 200 showing an example set of extracted clusters corresponding to a specific path, according to some embodiments.

Utilizing the grid, extracted, by adopting the algorithmic procedure described above, a consolidated routing optimization approach is proposed herein that incorporates past experience to its functionality by bounding the search space of alternative payment routes.

The search space can be bound by strategically limiting potential routes that the algorithm considers during the optimization process. By focusing on a subset of the most relevant and efficient pathways, the algorithm can operate more efficiently, reducing computational overhead and improving the accuracy of its routing decisions. This approach leverages historical data and clustering to predefine a smaller, more manageable set of candidate routes, thereby streamlining the search process.

Embodiments described herein bound the search space by utilizing the clusters identified through the convex hulls and their centroids, as described in the algorithmic procedure. Each cluster represents a group of similar payment trajectories with shared characteristics such as cost, processing time, and success rates. By restricting the search to these clusters, the algorithm excludes less relevant routes that are unlikely to be optimal based on historical performance. The targeted search speeds up the optimization process and increases the likelihood of finding the most efficient route as it focuses on pathways that have historically proven to effective.

The specific bounding approach can be informed by optimization requirements (e.g., payment amounts, transaction costs), which, for example, can be based on KPIs of end users. In some embodiments, alternative bounding approaches can be automatically proposed by the system, depending on user needs.

Each node composing the alternative route, belongs to a certain cluster (or set of clusters), described by a variety of features (e.g., mean, min, and max cost and time consumed to process payments inside the specific clusters). This set of features can be exploited accordingly to define also cost/rates adaptations/deviations, in alignment with certain type of constraints that a certain payment process should adhere to. An example holistic end-to-end procedure is described below to illustrate a consolidated approach for payment routing optimization utilizing trajectory mining.

Once the grid data structure is generated, the grid data structure can be transformed to attach a weighting (prop. dist.) that quantifies, depending on the initial-steady state of the system, the likelihood of each waypoint to be visited.

A quantum analog reinforcement learning algorithm is then instantiated, and the weightings are updated with real-time data. The quantum analog reinforcement learning algorithm operates by deriving an “optimal” policy by interacting with a dynamic environment where a probability distribution describing the network internal topology is updated in real-time by newly acquired data depending on the user-defined constraints.

In particular, the approach can include the following steps:

1. Let D be the initial dataset consisting of features describing payments conducted, and let V be the set of nodes in the financial network, corresponding to financial institutions processing payments. Let E be the set of edges in the financial network, corresponding to the payment processing pathways between nodes.

2. First, the data in D is filtered and clustered using the Douglas Peucker algorithm and density-based clustering approaches such as DBSCAN, resulting in a set of clusters C=C₁, C₂, . . . , Cₖ, where each Cᵢ is a set of data points (nodes) representing similar segments of routes in terms of origin, final destination, payment type, date processed, instructions, and payment status. The clusters are identified based on historical data.

Next, the A* algorithm is used to find a rough approximation of an optimal processing route between the originator and beneficiary banks. The broader network of financial channels is represented as a grid (G), where each node corresponds to a financial institution or waypoint. Let s be the originator node and t be the beneficiary node. A* proceeds as follows:
(a) let h(n) be an estimate of the remaining cost to the goal node t based on heuristics such as the Euclidean or Manhattan distance between nodes.
(b) Define the cost function ƒ(n)=g(n)+h(n).
(c) Initialize an empty priority queue Q and add the start node s with ƒ(s)=h(s).
(d) While Q is not empty, remove the node n with the lowest ƒ(n) value from Q.
(e) If n=t, terminate with the path found from s to t. Otherwise, expand n by adding its neighboring nodes to Q with updated g and ƒ values.

3. Let P={p₁, p₂, . . . , pₘ} be the set of nodes on the shortest path found by A* from s to t. For each pᵢ∈P, let Bᵢ be the set of nodes within a certain radius r of pᵢ. The value of r can be adjusted to control the granularity of the resulting clusters. Let

$${C}^{′} = \{ {C}_{1}^{′} , {C}_{2}^{′} , … , {C}_{n}^{′} \}$$

be the set of clusters obtained by intersecting the sets Bᵢ with the clusters in C, effectively bounding the search space for alternative payment routes. This algorithm uses heuristics to efficiently navigate the grid, aiming to minimize the total cost of the route by only considering routes that pass through nodes within the bounding clusters, significantly reducing the number of potential routes to evaluate. The historical trajectories within the selected clusters are mined to identify patterns and trends that can inform the routing decision. The algorithm then selected the optimal route that meets all specified constraints (cost, processing time, success rate, etc.) and leverages past successful routes.

4. For each cluster C′ᵢ ∈C′, let H be the convex hull of the nodes in C′ᵢ. Each polygon H describes a set of payment trajectories processed by banks through a set of nodes (candidate intermediate channels) (V₁, . . . , Vₘ). These trajectories are defined by a set of features corresponding to the processing rates, time consumed to complete the transaction, success rates, etc. For each cluster, the set of features is extracted, including statistical measures such as mean, minimum, and maximum values for cost, processing time, and success rates. These features characterize the typical performance of payment routes within the cluster. The features of each cluster are utilized to adapt or deviate the costs and rates in alignment with specific constraints of the payment process. For example, if a payment needs to adhere to a maximum processing time, the algorithm can prioritize clusters with lower mean processing times. The system continuously updates the clusters and their features with new historical data, ensuring that the optimization process remains effective as the network evolves.

5. Finally, to extract the set of clusters corresponding to the route found by A*, the centroid of each polygon π is computed to serve as a representative point for the cluster, and the distance from each centroid to each node on the path P is calculated. The distance between each node and the centroids of the clusters is calculated using a predefined metric that captures the similarity relating to payment type, rates, processing time, and other relevant features. The clusters with centroids closest to the nodes on the path P are selected as the ideal set of clusters containing segments of payment trajectories processed by banks along the route.

This methodology allows the extraction of patterns in payment trajectories within the financial network, and the identification of homogeneous payment partitions that can be exploited for further analysis and optimization, in the broader context of payment route planning.

As described herein, an innovative methodological approach applying trajectory mining (that is not limited to but can be applied for the banking sector), to extract an optimal payment route, subject to specific constraints. This approach aims to transcend beyond the strict sectoral boundaries of different domains and facilitate the banking system identify fraudulent activities as well as to optimize internally the day-to-day operation of financial institutions.

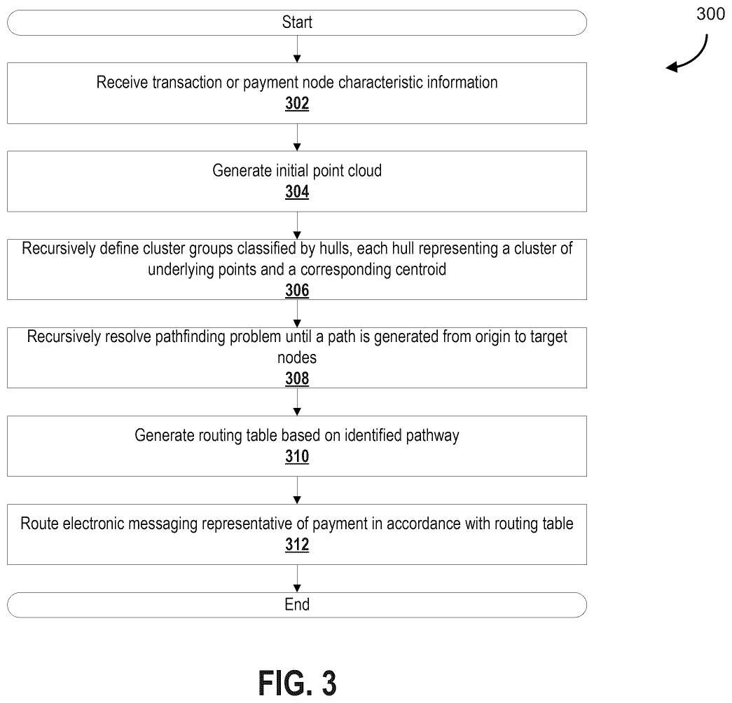

FIG. 3 is an example flow chart 300 representing a process performed by the data message routing system, according to some embodiments.

At 302, the system receives transaction or payment node characteristic information.

At 304, the system generates an initial point cloud with payment trajectory clusters. Each point inside the clusters represents a waypoint that belongs to a certain payment trajectory displayed in a two-dimensional or three-dimensional space. Each convex hull 104 represents the clustering outcome of multiple payment trajectories that meet certain criteria (e.g., type of payment, cost, processing time, etc.). For example, in the banking industry, the corresponding positions of the waypoints can be determined by coordinates representing the identifier of the financial institution that the payment was processed by and the particular timestamp of the payment. For example, in the maritime industry, the corresponding positions of the waypoints can be determined by coordinates representing the latitude, longitude, and timestamp of the vessels' positions.

At 306, the system recursively defines cluster groups classified by hulls, where each hull represents a cluster of underlying waypoints and a corresponding centroid. A convex hull 104 can be defined as a data structure or data object comprising a set of points, represented by coordinates, corresponding to historical payment routes (financial institution). The centroid of the convex hell 104 represents the inherent attributes of the points compiling the convex hull 104. For example, the centroid can be the point that is closest to the average of the attributes that comprise the cluster of points (e.g., average processing time, average amount of money, etc.). For example, the convex hull 104 can be defined as a computational region minimally encompassing a set of related points, and a process to determine the area or bounds of a convex hull 104 can include first identifying the set of members of the hull through a classification approach, and then drawing the bounded region, and finally establishing characteristics of each convex hull 104, based, for example, on a centroid of the convex hull 104.

At 308, the system recursively resolves the pathfinding problem until a path is generated from the origin node to the target node. Beginning with the initial node (representing the starting point), the system uses an algorithm to insert the initial node into the priority queue with its total cost calculated as ƒ=g+h. The priority queue, implemented as a min-heap, would prioritize this node.

The algorithm proceeds by iteratively selecting the node with the lowest ƒ(n) value from the priority queue, expanding it and its neighbors, calculating the nodes' respective ƒ(n) values, and adding its neighboring nodes to the priority queue. The algorithm continues until the goal node is reached, at which point the path is reconstructed, or the priority queue becomes empty, indicating that no path exists.

At 310, the system generates a routing table based on an identified pathway.

At 312, the system routes electronic messaging representative of payment in accordance with the routing table.

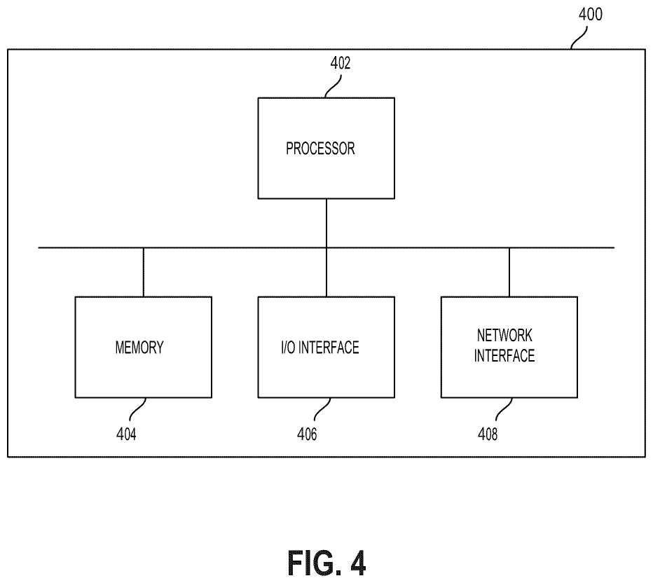

FIG. 4 is an example computing system diagram 400 showing an example practical computing system for implementing the system for optimizing data message routing, according to some embodiments. The computing device 400 can be a computer server or other physical computing hardware device, and may reside, for example, in a data center. The computing device 400 includes one or more computer processors (e.g., microprocessors) 402 which are adapted to execute machine interpretable instructions, and interoperates with computer memory 404 (e.g., read only memory, random access memory, integrated memory). An input/output interface 406 can be provided that receives data sets representing inputs from devices such as computer mice, keyboards, touch screens, among others, and provides outputs in the form of interface element control for rendering on computer displays, such as monitors. A network interface 408 is provided that is adapted for electronic communications with other computing devices, such as downstream computing systems, data storage elements, data backup servers, among others. The network interface 408 can include various types of interfaces, including wireless connection interfaces, wired connection interfaces, connections with messaging buses, among others.

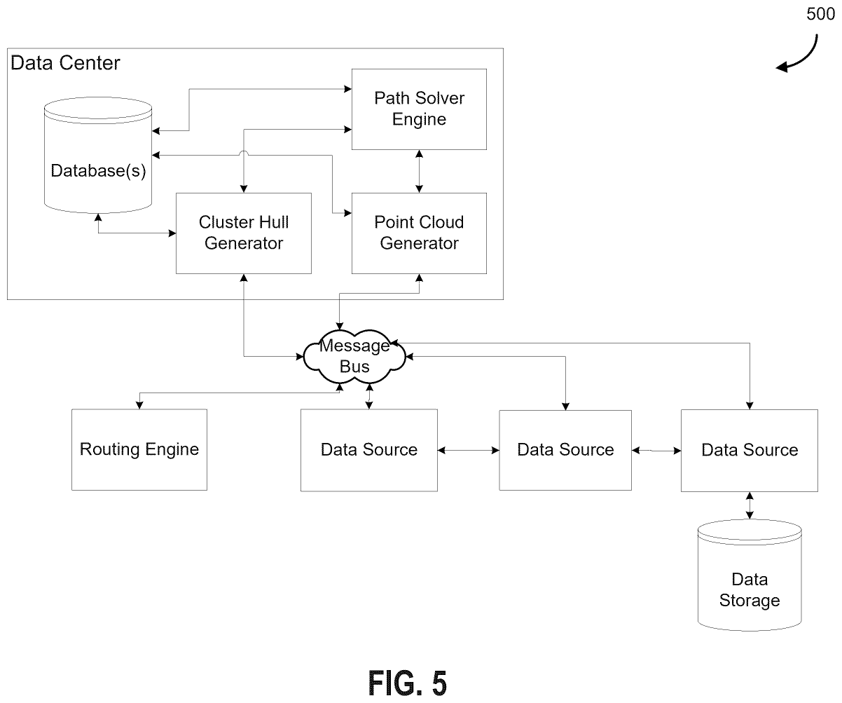

FIG. 5 is a block schematic diagram of an example system, according to some embodiments.

A data center may be comprised of a path solver engine, point cloud generator, cluster hull generator and data base(s). The data center may be configured to store all point clouds generated by the point cloud generator, cluster hulls determined by the cluster hull generator, and paths found by the path solver engine into the database(s).

The data center is configured to access historical data stored in one or more data sources and data storage through a message bus. Historical trajectories data can be mined to identify patterns and trends that can inform a routing decision.

The point cloud generator is configured to map a network of financial channels onto a grid, where each node corresponds to a financial institution or waypoint. The point cloud generator can process features and convert them into spatial representations for a point cloud or grid representation.

The cluster hull generator is configured to generate cluster hulls by identifying clusters of similar payment trajectories based on historical data where each cluster is represented by a convex hull that encompasses all the nodes (candidate intermediate channels) on its boundary. The cluster hull generator calculates the centroid of each convex hull to serve as a representative point for the cluster.

For each cluster, the cluster hull generator can extract a set of features, including statistical measures such as mean, minimum, and maximum values for cost, processing time, and success rates. These features characterize the typical performance of payment routes within the cluster. The cluster hull generator can then transmit the extracted features to the point cloud generator for mapping onto spatial representations. The cluster hull generator can transmit the cluster hulls and extracted features to the path solver engine for finding the shortest path.

The path solver engine is configured to employ the A* algorithm and find the shortest path from the start point to the end point. The path solver engine can receive cluster hulls from the cluster hull generator to calculate the distance between each node and the centroids of the cluster hulls. The path solver engine is configured to select the optimal route that meets all specified constraints from the features received from the cluster hull generator and leverages past successful routes received through the message bus from data sources and storage.

The routing engine generates a routing table based on the identified optimal pathway and routes electronic messaging representative of payment in accordance with the routing table.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A computing system configured for generate data message routing instructions for routing one or more data messages between an origin node and a target node through a sequence of waypoint nodes selected from a constellation of candidate waypoint nodes, each waypoint node of the constellation of candidate waypoint nodes associated with a plurality of characteristics, the computing system comprising:
a computer processor coupled to non-transitory computer memory, the computer processor configured to:
generate a plurality of clusters using a trained machine learning model, each cluster represented by a convex hull of a subset of candidate waypoint nodes;
determine whether a path can be established between a first cluster corresponding to the origin node and second cluster corresponding to the target node, the path bounded by a set of optimized computing constraints;
upon determining that the path can be established between the first cluster and the second cluster, decompose the first cluster and the second cluster, and generate a candidate pathway representing the sequence of waypoint nodes for the routing of the one or more data messages; or
upon determining that the path cannot be established between the first cluster and the second cluster, recursively generate a further plurality of sub-clusters to generate a plurality of convex sub-hulls, and recursively attempt to determine whether the path can be established at increasingly levels of recursive depth; and
transform the candidate pathway into a series of the data message routing instructions for controlling the routing of the one or more data messages between the origin node and the target node.

2. The computing system of claim 1, wherein the plurality of characteristics is a high dimensionality set of parameters based at least on extended operational metrics obtained from tracked prior interactions with the waypoint node.

3. The computing system of claim 2, wherein a determination for determining whether the path can be established includes attaching a weighting distribution that quantifies, depending on an initial steady state, a likelihood of each particular waypoint node or generated convex hull to be visited.

4. The computing system of claim 1, wherein each convex hull or sub-hull of the plurality of convex hulls or sub-hulls is represented by a generated centroid during path determination, the generated centroid generated based on a representative classification of points within the convex hull or sub-hull.

5. The computing system of claim 4, wherein at each recursive stage other than a final recursive stage, the candidate pathway includes a path generated between one or more generated centroids.

6. The computing system of claim 1, wherein a batch pre-processing step is utilized to pre-compute a plurality of clusters and corresponding pluralities of sub-clusters up to a pre-determined depth level for storage on a pre-calculation database to be accessed during run-time.

7. The computing system of claim 6, wherein recursion beyond the pre-determined depth level includes generating additional pluralities of sub-clusters in run-time.

8. The computing system of claim 1, wherein the data message routing instructions are represented in the form of a routing table.

9. The computing system of claim 8, wherein the routing table is utilized during run-time execution of a payment process request by controlling the routing of the one or more data messages corresponding to the payment process between the origin node and the target node through the selected waypoint nodes of the candidate pathway.

10. The computing system of claim 1, wherein the computing system is a special purpose computing appliance coupled to a message bus and configured for generating the candidate pathway in response to received proposed payment transactions between the origin node and the target node.

11. A computing method for generating data message routing instructions for routing one or more data messages between an origin node and a target node through a sequence of waypoint nodes selected from a constellation of candidate waypoint nodes, each waypoint node of the constellation of candidate waypoint nodes associated with a plurality of characteristics, the method comprising:
generating a plurality of clusters using a trained machine learning model, each cluster represented by a convex hull of a subset of candidate waypoint nodes;
determining whether a path can be established between a first cluster corresponding to the origin node and second cluster corresponding to the target node, the path bounded by a set of optimized computing constraints;
upon determining that the path can be established between the first cluster and the second cluster, decomposing the first cluster and the second cluster, and generating a candidate pathway representing the sequence of waypoint nodes for the routing of the one or more data messages; or
upon determining that the path cannot be established between the first cluster and the second cluster, recursively generating a further plurality of sub-clusters to generate a plurality of convex sub-hulls, and recursively attempting to determine whether the path can be established at increasingly levels of recursive depth; and
transforming the candidate pathway into a series of the data message routing instructions for controlling the routing of the one or more data messages between the origin node and the target node.

12. The computing method of claim 11, wherein the plurality of characteristics is a high dimensionality set of parameters based at least on extended operational metrics obtained from tracked prior interactions with the waypoint node.

13. The computing method of claim 12, wherein a determination for determining whether the path can be established includes attaching a weighting distribution that quantifies, depending on an initial steady state, a likelihood of each particular waypoint node or generated convex hull to be visited.

14. The computing method of claim 11, wherein each convex hull or sub-hull of the plurality of convex hulls or sub-hulls is represented by a generated centroid during path determination, the generated centroid generated based on a representative classification of points within the convex hull or sub-hull.

15. The computing method of claim 14, wherein at each recursive stage other than a final recursive stage, the candidate pathway includes a path generated between one or more generated centroids.

16. The computing method of claim 11, wherein a batch pre-processing step is utilized to pre-compute a plurality of clusters and corresponding pluralities of sub-clusters up to a pre-determined depth level for storage on a pre-calculation database to be accessed during run-time.

17. The computing method of claim 16, wherein recursion beyond the pre-determined depth level includes generating additional pluralities of sub-clusters in run-time.

18. The computing method of claim 11, wherein the data message routing instructions are represented in the form of a routing table.

19. The computing method of claim 18, wherein the routing table is utilized during run-time execution of a payment process request by controlling the routing of the one or more data messages corresponding to the payment process between the origin node and the target node through the selected waypoint nodes of the candidate pathway.

20. A non-transitory computer readable medium storing computer interpretable instruction sets, which when executed by a processor, cause the processor to perform a computing method for generating data message routing instructions for routing one or more data messages between an origin node and a target node through a sequence of waypoint nodes selected from a constellation of candidate waypoint nodes, each waypoint node of the constellation of candidate waypoint nodes associated with a plurality of characteristics, the method comprising:
generating a plurality of clusters using a trained machine learning model, each cluster represented by a convex hull of a subset of candidate waypoint nodes;
determining whether a path can be established between a first cluster corresponding to the origin node and second cluster corresponding to the target node, the path bounded by a set of optimized computing constraints;
upon determining that the path can be established between the first cluster and the second cluster, decomposing the first cluster and the second cluster, and generating a candidate pathway representing the sequence of waypoint nodes for the routing of the one or more data messages; or
upon determining that the path cannot be established between the first cluster and the second cluster, recursively generating a further plurality of sub-clusters to generate a plurality of convex sub-hulls, and recursively attempting to determine whether the path can be established at increasingly levels of recursive depth; and
transforming the candidate pathway into a series of the data message routing instructions for controlling the routing of the one or more data messages between the origin node and the target node.
